(19) United States
(12) Patent Application Publication
(10) Pub. No.: US 2014/0208695 A1
(43) Pub. Date: Jul. 31, 2014

(54) ROLL-FED SHRINK FILM

(71) Applicant: Noel Mitchell, Wuppertal (DE)

(72) Inventor: Noel Mitchell, Wuppertal (DE)

(73) Assignee: UPM RAFLATAC OY, Tampere (FI)

(21) Appl. No.: 14/130,506

(22) PCT Filed: Jun. 29, 2012
(86) PCT No.: PCT/FI2012/050683

§ 371 Date: Jan. 29, 2014

Related U.S. Application Data
(60) Provisional application No. 61/503,651, filed on Jul. 1, 2011.

(30) Foreign Application Priority Data
Jul. 1, 2011 (FI) 20115706

(51) Int. Cl. B65B 53/02; B29C 47/00; B65B 69/00; B32B 27/32; B65B 51/02; B65B 51/22

(52) U.S. Cl. CPC B65B 53/02; B65B 51/02; B65B 51/225; B65B 69/0033; B32B 27/32; B29C 47/0057
USPC 53/442; 53/492; 428/516; 264/173.15

(57) ABSTRACT

The invention relates to a shrink film having a multilayer structure, wherein the core layer of the film includes polypropylene, hydrocarbon resin and block-copolymer rubber. The invention also relates to a label including said film and to use of films for labelling recyclable or reusable items. Further the invention relates to a method for producing shrink film, to a method for attaching a shrink film to an article, and to a method separating a shrink film from an article.

### FIELD OF THE INVENTION

The present invention relates to plastic films. More specifically, the invention relates to roll-fed shrink films for labelling applications.

### BACKGROUND OF THE INVENTION

Heat-shrinkable films are well known in the art and can be used in a variety of applications, such as shrink wraps, coverings, and labels for beverage and home and personal care products.

WO2009111058 discloses polyester blends useful for preparation of shrinkable films, and heat-shrinkable films prepared therefrom. The heat shrinkable film may be oriented in the machine direction to produce films with high machine-direction shrinkage but low transverse growth or shrinkage. The films are useful for roll-fed, shrink-on label applications. Also disclosed are heat-shrinkable roll-fed labels prepared from reactor-grade polyesters.

### SUMMARY OF THE INVENTION

It is an object to provide economical and environmentally friendly plastic film for labelling applications, which may be applied to articles having high curvature design and may be subsequently separated from the articles, such as bottles comprising polyester, in the normal flotation washing process during the re-use or recycling of the articles.

These objects can be achieved with films described in the present application.

According to a first aspect of the invention there is provided a shrink film having a multilayer structure. The multilayer structure may comprise a core layer having a first surface and a second surface, a first skin layer on the first surface of the core layer, and a second skin layer on the second surface of the core layer. Said core layer comprises polypropylene homopolymer, hydrocarbon resin and block-copolymer rubber.

According to a second aspect of the present invention there is provided a use of the shrink film for labelling recyclable or reusable items.

According to a third aspect of the present invention a label comprising the shrink film is provided.

According to a fourth aspect of the present invention a method for producing a shrink film is provided. The method comprises at least following steps. Manufacturing of a non-oriented multilayer film, which comprises a core layer having a first surface and a second surface, a first skin layer on the first surface of the core layer and a second skin layer on the second surface of the core layer. Said core layer comprises polypropylene homopolymer, hydrocarbon resin and block-copolymer rubber. Stretching said non-oriented multilayer film from 7 to 8 times in machine direction at temperature between 130 and 160° C. followed by cooling the stretched film at temperature between 50 and 80° C., so as to form a shrink film.

According to a fifth aspect of the present invention there is provided a method for attaching a film to an article, wherein the film comprises a core layer including polypropylene homopolymer, hydrocarbon resin and block-copolymer rubber. The method comprises at least following steps. Wrapping a film around an article, wherein a machine direction of the oriented film extends circumferentially around the article; seaming said film through gluing, laser welding, heat sealing, or ultrasonic bonding; heating the film at temperature between 120 and 130° C. so as to form a tight fitting film for the article.

According to a sixth aspect of the present invention there is provided a method for separating a shrink film from a surface of an article, wherein the shrink film comprises a core layer including polypropylene homopolymer, hydrocarbon resin and block-copolymer rubber. The method comprises at least exposing the film and the article to flotation separation process.

Further embodiments of the invention are presented in dependent claims.

The shrink film may have a composition having an amount of polypropylene homopolymer between 50 and 80 weight-%, an amount of hydrocarbon resin between 10 and 25 weight-%, and an amount of block-copolymer rubber between 10 and 25 weight-%.

The shrink film may have a composition having an amount of polypropylene 80 wt-%, an amount of hydrocarbon resin 10 wt-%, and an amount of block-copolymer rubber 10 wt-%.

The shrink film may have the block-copolymer rubber at least one of the following: styrene-butylene/styrene, styrene-isoprene/styrene, styrene-ethylene/butylene-styrene, styrene-ethylene/propylene-styrene, styrene-ethylene-ethylene/propylene-styrene or styrene-ethylene/propylene block copolymer.

The core layer of the shrink has a haze less than 15%, preferably less than 10%.

The first and second skin layer of the multilayer structure of the shrink film may comprise polypropylene homopolymer.

The multilayer film may be oriented approximately from 7 to 8 times in machine direction.

Shrinkage of the multilayer film may be between 30 and 40% at temperature between 120 and 130° C.

Overall density of the film may be less than 1 g/cm³.

The film may be applied to the article which is recyclable or reusable plastic bottle or container.

The film may be applied to the article which has a highly contoured surface profile.

### DESCRIPTION OF THE DRAWINGS

In the following examples, the embodiments of the invention will be described in more detail with reference to the appended drawings, in which

FIG. 1 shows, in a cross sectional view, a multilayer film structure,

FIG. 2a shows a film wrap around the surface of an article,

FIG. 2b shows a film attached to the surface of an article.

### DETAILED DESCRIPTION OF THE INVENTION

According to the invention, a roll-fed shrink film is provided for decoration and/or identification of articles used in beverage and/or home and personal care products, such as bottles, containers or other packages. The articles may be reusable or re-cyclable.

Roll-Fed shrink films, i.e. films which are machine direction oriented, are used in wrap-around label applications and may be applied using a continuous roll process.

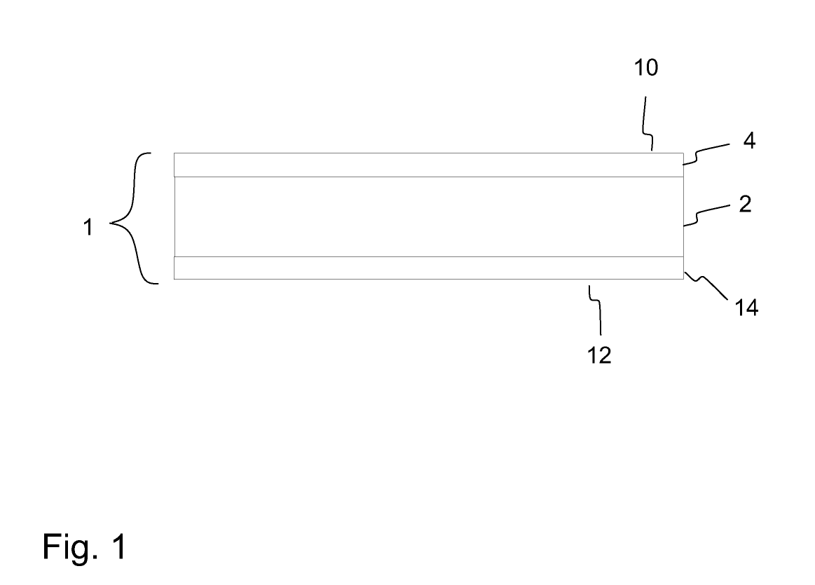

Referring to FIG. 1, roll-fed shrink film 1 may have a multilayer structure comprising two or more plastic film layers. The multilayer structure comprises a core layer 2 having a first surface and a second surface, a first skin layer 4, and a second skin layer 14. The first skin layer 4 is adjacent to the first surface of the core layer 4. The second skin layer 14 is adjacent to the second surface of the core layer 4. Preferably the multilayer structure has symmetric structure comprising a core layer and identical skin layers on the upper surface and on the lower surface of the core layer. The film structure may also comprise additional layers, such as tie layers or protective layers. The multilayer structure may be laminated or coextruded.

Typically, the core layer 4 comprises major portion of the multilayer film structure. The thickness of the core layer may be from 30 to 50 microns, preferably around 40 microns. The thickness of each skin layer may be less than 20 microns, preferably around 10 microns or less. The overall thickness of the multilayer film may be from 50 to 70 microns, preferably around 60 microns or less. Preferably the multilayer film has controlled and very uniform thickness.

The multilayer structure comprises layers having different compositions. Preferably a core layer 2 of the multilayer film 1 comprises a mixture of polypropylene homopolymer, block-copolymer rubber and hydrocarbon resin (HC). Polypropylene homopolymers refer to polymers comprising only propylene as repeating monomer unit. Preferred hydrocarbon resins are low molecular weight polymers/oligomers consisting of hydrocarbons. For example, weight average molecular weight (M_{w}) may be around 1500 Da and M_{w}/Mₙ may be around 1.7. Said resins may also be amorphous. Hydrocarbon resins may be partially or fully hydrogenated. Suitable resins are synthetic, for example petroleum based resins. Hydrocarbon resin may be a hydrogenated acyclic hydrocarbon resin, fully hydrogenated to a saturated aliphatic acyclic hydrocarbon resin, saturated aliphatic cyclic (cyclo-aliphatic) hydrocarbon resin compound, or a mixture of two or more thereof. The block-copolymer rubber may be styrenic copolymer comprising styrene derived units and one or more other monomer units, for example ethylene, propylene, isoprene and butylene. The block-copolymer rubber may be at least one of the following: styrene-butylene/styrene (SBS), styrene-isoprene/styrene (SIS), styrene-ethylene/butylene-styrene (SEBS), styrene-ethylene/propylene-styrene (SEPS), styrene-ethylene-ethylene/propylene-styrene (SEEPS) or styrene-ethylene/propylene (SEP) block copolymer.

The core layer 2 may have a composition including between 50 and 80% by weight, based on the total weight of the core layer, PP homopolymer, between 10 and 25 weight-% HC resin, and between 10 and 25 weight-% block-copolymer rubber, preferably between 60 and 80 wt-% PP homopolymer, 10-20 wt-% HC resin and 10-20 wt-% block-copolymer rubber, and more preferably 80 wt-% PP homopolymer, 10 wt-% HC resin and 10 wt-% block-copolymer rubber.

According to the invention, the core layer is preferably clear. The clarity of the film can be measured by the haze values. The haze of the core layer is less than 25%, preferably less than 15%, and most preferably less than 10%. Haze values referred to in this application are determined according to standard ASTM D1003.

The skin layer 4,14 of a multilayer structure 1 may comprise at least one polypropylene homopolymer. Alternatively the skin layer(s) may comprise polypropylene in mixtures with at least one of the following: random polypropylene copolymer, polypropylene block-copolymer, linear low density polyethylene (LLDPE) or high density polyethylene (HDPE). Minor amount of additives may also be included, for example anti-blocking agent.

For example, a multilayer film may comprise a core layer having 80 wt-% PP homopolymer, 10 wt-% HC resin and 10 wt-% SEBS. The skin layer may include only PP homopolymer.

Unoriented multilayer films may be manufactured by using either a cast or blown-film extrusion process. A shrinkable multilayer film may be obtained by stretching (drawing) the extruded multilayer film to an extent several times its original dimension to orient the film. Stretching may be designated also as orienting. The stretching may be performed by using heated draw rolls with gradually increasing speed. The stretching may be performed below the melting temperature of the polymer and/or at or near the glass transition temperature of the polymer. Preferably the film stretching temperature is between 130 and 160° C., preferably between 140 and 150° C. The film may be uniaxially oriented, i.e. stretched only in the machine direction (MD). MD is the longitudinal direction of the film in which the film is produced on a film making machine. The film is oriented approximately from 5 to 10 times, preferably 6 to 9 times, and most preferably from 7 to 8 times in machine direction. Alternatively the film may be biaxially oriented, i.e. oriented to some degree both in the machine and transverse directions (TD). Transverse direction of the film is the direction perpendicular to the MD of the film.

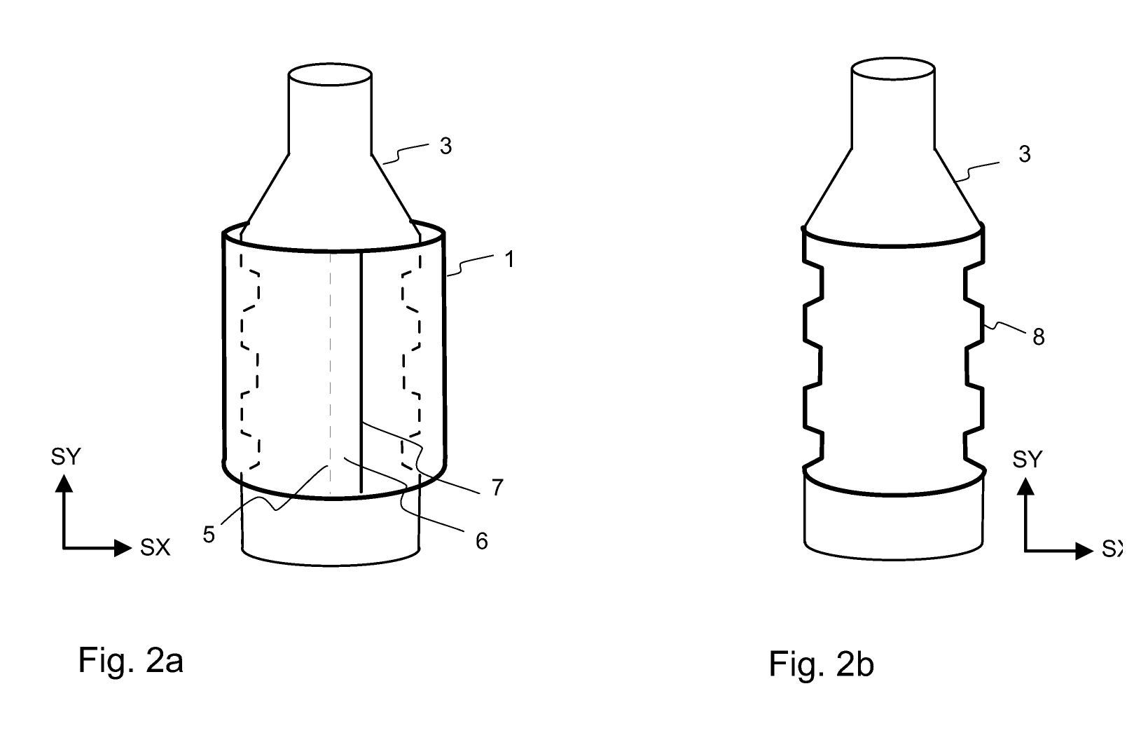

Transverse direction is also known as the cross direction (CD). Referring to the FIG. 2a, the machine direction of the film is the direction SX and the transverse direction SY. However, in biaxially oriented films the primary degree of orientation is in the machine direction of the film (MD), i.e. the orientation is greater in the machine direction than in the transverse direction.

After the stretching the film is not heat set, i.e. not annealed, to provide maximum shrinkage for the multilayer shrink film. After stretching at elevated temperature the oriented film is immediately cooled by passing the film through cooling rolls. Cooling temperature is preferably between 40 and 100° C., preferably between 50 and 80° C., and most preferably between 50 and 60° C. Consequently, subsequent application of heat causes the oriented film to relax and the oriented film may return substantially back to its original unstretched dimensions. Thus, machine direction oriented films primarily shrink in the machine direction.

The oriented multilayer films, i.e. shrink films are printable. Films may be printed with traditional printing processes, in order to provide visual effect and/or to display information. For example, any conventional printing technique including flexographic, gravure and offset processes can be used. The multilayer film may be printed from a face side 10 of the film 1. Alternatively the reverse side 12 of the film may be printed. Thus the graphic patterns may be printed on at least one of the on the skin layer of the multilayered film. In printing the reverse side 12 of the film a reverse-printed film is created. The printed side of the reverse-printed film is in direct contact with the substrate to which the film is applied and the printing is viewed through the multilayer film.

Roll-fed shrink films may be applied to an article with a combination of seaming and shrink technique. An article will be designated also as an item or a substrate. Referring to FIG. 2a, a film 1 may be wrapped around an item 3. Preferably a machine direction of the oriented film extends circumferentially around the item. Thus it is possible to provide 360° decoration for the item. The machine direction of the film is indicated by the SX in the FIG. 2a. The opposite edges 5,7 of the film may overlap and form a seam 6. The seam 6 may comprise an adhesive layer, such as a hot melt or UV-curable adhesive. Alternatively, the seaming may be performed using other methods known in the art, such as laser welding, heat sealing, or ultrasonic bonding. The item having a film wrapped around is subsequently heated causing the film to shrink and to conform to the surface of the item thereby creating a tight fitting label 8 for the article 3, as shown in FIG. 2b. The label (8) provides a smooth and consistent coating for the item. The heating temperature of the film may be between 80 and 150° C., preferably between 120 and 130° C. Labels comprising machine direction oriented films preferably shrink in the direction (SX) extending circumferentially around the item. The heat that induces shrinkage can be provided by conventional heat sources, such as hot steam, heated air, infrared radiation, or the like. The item may be highly contoured containers, such as shampoo and detergent bottles, and drink containers. The item may also be recyclable. The label may be a full body label, i.e. the label may cover the whole outer surface of the item. Alternatively, the label may cover the item only partially.

The multilayer shrink films and labels comprising said films are characterized by good visual appearance, i.e. optical clarity. The film may be a clear plastic film providing a no-label look or appearance. The clear plastic film is substantially transparent to visible light. The clear no-label look of the film allows the objects beneath such film, i.e. the bottle or contents, to be visible through such film. An advantage of the present invention is that machine direction oriented shrinkable films with high clarity and low haze can be obtained. The overall haze of the multilayer film may be less than 25%, preferably less than 15%, and most preferably less than 10.

Another advantage is that the multilayer shrink film is suitable for printing and provides excellent printing quality. For example, readable and aesthetically acceptable reverse side printing of the multilayer film can be achieved. Thanks' to the excellent ink adhesion and register control of the film it may be gravure printed.

Additionally, the multilayer films and labels comprising said films have controlled shrinkage. The films have an ability upon exposure to some level of heat to shrink. This ability is activated when the film is treated at elevated temperatures, such as passed through a hot air. The film of the present invention is suitable for a wide range of product designs and particularly suitable for highly contoured containers and products. The shrink performance, i.e. shrinking capacity of the films in the machine direction is very high at elevated temperatures. The shrinkage of the films is between 20 and 50%, preferably between 25 to 45% and most preferably between 30 and 40% under normal shrink film and label application temperatures between 80 and 150° C., preferably between 120 and 130° C. In cross direction the films have shrinkage less than 10%, preferably less than 7%, most preferably less than 5%. The shrink performance of the film is adequate in order to conform the film to the profile of the substrate. Wide range of substrate, such as bottle, designs may be used.

Thanks to the composition of multilayer film the overall density of the film is less than 1 g/cm³, preferably between 0.99 and 0.90 g/cm³ or less. Use of said multilayer film facilitates recycling and/or reuse of the articles labelled, such as bottles or other containers. Lower density of the film allows the film and label comprising said film to be more easily separated from the substrates having higher density, such as PET bottles. Said film density allows the films to be separated from the substrate material during recycling process, for example in the normally used washing process of the bottles, i.e. flotation separation process, of the bottles or other containers. The separated labels may also be further recycled.

According to an aspect of the invention there is provided a shrink film having a multilayer structure. The multilayer structure may comprise a core layer having a first surface and a second surface, a first skin layer on the first surface of the core layer, and a second skin layer on the second surface of the core layer. Said core layer comprises homopolypropylene, hydrocarbon resin and block-copolymer rubber.

According to an aspect of the invention there is provided a shrink film having a multilayer structure. The multilayer structure may comprise a core layer having a first surface and a second surface, a first skin layer on the first surface of the core layer, and a second skin layer on the second surface of the core layer. Said core layer comprises polypropylene, hydrocarbon resin and block-copolymer rubber.

According to an aspect of the present invention a method for producing a shrink film is provided. The method comprises at least following steps. Manufacturing of a non-oriented multilayer film, which comprises a core layer having a first surface and a second surface, a first skin layer on the first surface of the core layer and a second skin layer on the second surface of the core layer. Said core layer comprises homopolypropylene, hydrocarbon resin and block-copolymer rubber. Stretching said non-oriented multilayer film from 7 to 8 times in machine direction at temperature between 130 and 160° C. followed by cooling the stretched film at temperature between 50 and 80° C., so as to form a shrink film.

According to an aspect of the present invention a method for producing a shrink film is provided. The method comprises at least following steps. Manufacturing of a non-oriented multilayer film, which comprises a core layer having a first surface and a second surface, a first skin layer on the first surface of the core layer and a second skin layer on the second surface of the core layer. Said core layer comprises polypropylene, hydrocarbon resin and block-copolymer rubber. Stretching said non-oriented multilayer film from 7 to 8 times in machine direction at temperature between 130 and 160° C. followed by cooling the stretched film at temperature between 50 and 80° C., so as to form a shrink film.

According to an aspect of the present invention there is provided a method for attaching a film to an article, wherein the film comprises a core layer including homopolypropylene, hydrocarbon resin and block-copolymer rubber. The method comprises at least following steps. Wrapping a film around an article, wherein a machine direction of the oriented film extends circumferentially around the article; seaming said film through gluing, laser welding, heat sealing, or ultrasonic bonding; heating the film at temperature between 120 and 130° C. so as to form a tight fitting film for the article.

According to an aspect of the present invention there is provided a method for attaching a film to an article, wherein the film comprises a core layer including polypropylene, hydrocarbon resin and block-copolymer rubber. The method comprises at least following steps. Wrapping a film around an article, wherein a machine direction of the oriented film extends circumferentially around the article; seaming said film through gluing, laser welding, heat sealing, or ultrasonic bonding; heating the film at temperature between 120 and 130° C. so as to form a tight fitting film for the article.

According to an aspect of the present invention there is provided a method for separating a shrink film from a surface of an article, wherein the shrink film comprises a core layer including homopolypropylene, hydrocarbon resin and block-copolymer rubber. The method comprises at least exposing the film and the article to flotation separation process.

According to an aspect of the present invention there is provided a method for separating a shrink film from a surface of an article, wherein the shrink film comprises a core layer including polypropylene, hydrocarbon resin and block-copolymer rubber. The method comprises at least exposing the film and the article to flotation separation process.

The shrink film may have a composition having an amount of polypropylene homopolymer between 50 and 80 weight-%, an amount of hydrocarbon resin between 10 and 25 weight-%, and an amount of block-copolymer rubber between 10 and 25 weight-%. Alternatively, instead of polypropylene homopolymer (homopolypropylene), the film may comprise a random copolymer or a block-copolymer of propylene. Alternatively, the film may comprise a blend of at least two of the following polypropylenes: a polypropylene homopolymer, a polypropylene random copolymer, a polypropylene block-copolymer.

The first and second skin layer of the multilayer structure of the shrink film may comprise polypropylene homopolymer. It is also possible that the skin layers comprise polypropylene random copolymer, polypropylene block-copolymer or a blend comprising at least two of the above mentioned polypropylenes.

Shrinkage of the multilayer film may be at least 30% at temperature between 120 and 130° C. Shrinkage of the multilayer film may be between 30 and 40% at temperature between 120 and 130° C.

The shrink film may have a composition having an amount of polypropylene 80 wt-%, an amount of hydrocarbon resin 10 wt-%, and an amount of block-copolymer rubber 10 wt-%. The polypropylene may be a homopolymer comprising only propylene as repeating unit. Alternatively the polypropylene may be a copolymer composed of two different repeat units: propylene and comonomer. The comonomers may be olefins, such as ethylene or butene. The polypropylene copolymer (propylene copolymer) may be a block copolymer or a random copolymer. In a random copolymer the two different units are randomly dispersed along the chain. A block copolymer is one in which identical repeat units are clustered in blocks along the chain.

Alternatively, the shrink film may comprise at least 30 wt-%, preferably at least 40 wt-% or at least 50 wt-% polypropylene as a main component. The polypropylene may be a homopolymer, a block copolymer, a random copolymer or any blend thereof. The total amount of other components, such as hydrocarbon resin and block-copolymer rubber, may be at most 70 wt-%, preferably at most 60 wt-%, or at most 50 wt-%. The amount of block-copolymer rubber may be less than the amount of hydrocarbon resin. Also minor amount of additives may be included.

The shrink film may have a composition having an amount of polypropylene homopolymer between 50 and 80 weight-%, an amount of hydrocarbon resin between 10 and 25 weight-%, and an amount of block-copolymer rubber between 10 and 25 weight-%. Alternatively, instead of polypropylene homopolymer, the film may comprise a random copolymer or a block-copolymer of propylene. Alternatively, the film may comprise a blend of at least two of the following polypropylenes: a polypropylene homopolymer, a polypropylene random copolymer, a polypropylene block-copolymer.

According to an example, a shrink film (1) has a multilayer structure comprising:
a core layer (2) having an first surface and a second surface;
a first skin layer (4) on the first surface of the core layer;
a second skin layer (14) on the second surface of the core layer,
   wherein the core layer (2) comprises polypropylene homopolymer, hydrocarbon resin and block-copolymer rubber.

The skin layer 4,14 of a multilayer structure 1 may comprise at least one polypropylene homopolymer. Alternatively the skin layer(s) may comprise polypropylene in mixtures with at least one of the following: random polypropylene copolymer, polypropylene block-copolymer, linear low density polyethylene (LLDPE) or high density polyethylene (HDPE). Minor amount of additives may also be included, for example anti-blocking agent.

The skin layer of a multilayer structure comprises at least one type of polypropylene, which is a homo polypropylene, a random polypropylene copolymer or a polypropylene block-copolymer. The polypropylene in the film may also be a blend of at least two of the following: a homo polypropylene, a random polypropylene copolymer, a polypropylene block-copolymer. Alternatively, the skin layer may comprise a mixture of polypropylene with linear low density polyethylene (LLDPE) or high density polyethylene (HDPE). It is also possible that the core layer and the skin layers have same composition. For example, the core layer may comprise polypropylene which is a homo polypropylene, a random polypropylene copolymer, a polypropylene block-copolymer, or any blend thereof. Preferably, in addition to polypropylene, the core comprises also hydrocarbon resin and block-copolymer rubber.

According to an example, the film comprises a random copolymer of polypropylene. In addition, the film comprises a styrenic block-copolymer rubber, such as SEBS, a hydrocarbon resin and PP homopolymer. Thus, the film includes both polypropylene homopolymer and polypropylene copolymer. In a multilayer structure, e.g. in a three layer structure, separate film layers may have same composition. In other words, the core and the skin layers may have same composition. The composition of the films in a multilayer structure may be, for example, 50 wt-% random PP copolymer, 30 wt-% SEBS and 20 wt-% HC resin master batch. The HC resin master batch may comprise, for example, 60% HC resin and 40% homo PP. For example, SEBS may be Kraton G1643, random PP copolymer may be Borealis RB 501 BF and HC master batch may be Polyone MDPPH6025.

The shrinkage of the multilayer film is preferably at least 30% in the machine direction of the film. For example, the shrinkage may be at temperature between 120 and 130° C. between 30 and 80%, preferably between 40 and 70%. Thanks to the same composition in all layers of the multilayer film the high shrinkage values may be achieved, for example between 40 and 70% at temperature between 120 and 130° C.

For the person skilled in the art, it will be clear that modifications and variations of the devices and the methods according to the present invention are perceivable. The drawings are schematic. The particular embodiments described above with reference to the accompanying drawings are illustrative only and not meant to limit the scope of the invention, which is defined by the appended claims.

1. A shrink film (1) having a multilayer structure comprising:
a core layer (2) having an first surface and a second surface;
a first skin layer (4) on the first surface of the core layer;
a second skin layer (14) on the second surface of the core layer,
wherein the core layer (2) comprises polypropylene, hydrocarbon resin and block-copolymer rubber.

2. The shrink film according to claim 1, wherein an amount of polypropylene is between 50 and 80 weight-%, an amount of hydrocarbon resin is between 10 and 25 weight-%, and an amount of block-copolymer rubber is between 5 and 35 weight-%.

3. The shrink film according to claim 1, wherein an amount of polypropylene is between 50 and 80 weight-%, an amount of hydrocarbon resin is between 10 and 25 weight-%, and an amount of block-copolymer rubber is between 10 and 25 weight-%.

4. The shrink film according to claim 1, wherein an amount of polypropylene is 80 wt-%, an amount of hydrocarbon resin is 10 weight-%, and an amount of block-copolymer rubber is 10 weight-%.

5. The shrink film according to any of the previous claims, wherein the block-copolymer rubber is at least one of the following: styrene-butylene/styrene, styrene-isoprene/styrene, styrene-ethylene/butylene-styrene, styrene-ethylene/propylene-styrene, styrene-ethylene-ethylene/propylene-styrene, or styrene-ethylene/propylene block copolymer.

6. The shrink film according to any of the previous claims, wherein the polypropylene is at least one of the following: a homopolymer, a random copolymer, or a block-copolymer.

7. The shrink film according to any of the previous claims, wherein a haze of the core layer (2) is less than 15%.

8. The shrink film according to any of the previous claims, wherein the first and second skin layer comprises polypropylene homopolymer, polypropylene random copolymer, polypropylene block-copolymer or any blend thereof.

9. The shrink film according to any of the previous claims, wherein the film (1) is oriented from 7 to 8 times in machine direction.

10. The shrink film according to any of the previous claims, wherein shrinkage of the film (1) is at least 30% at temperature between 120 and 130° C.

11. The shrink film according to the claims 1-9, wherein shrinkage of the film (1) is between 30 and 40% at temperature between 120 and 130° C.

12. The shrink film according to any of the previous claims, wherein the overall density of the film is less than 1 g/cm³.

13. A use of the shrink film (1) according to any of the claims 1-12 for labelling recyclable or reusable items (3).

14. A label (8) comprising a shrink film (1) according to any of the claims 1-12.

15. A method for producing a shrink film (1), the method comprising:
producing of a non-oriented multilayer film comprising a core layer (2) having a first surface and a second surface, a first skin layer (4) on the first surface of the core layer and a second skin layer (14) on the second surface of the core layer, wherein the core layer comprises polypropylene, hydrocarbon resin and block-copolymer rubber;
stretching said non-oriented multilayer film from 7 to 8 times in machine direction at temperature between 130 and 160° C.; and
cooling the stretched film at temperature preferably between 50 and 80° C. so as to form a shrink film (1).

16. A method for attaching a shrink film (1) to an article (3), wherein the film comprises a core layer (2) including polypropylene, hydrocarbon resin and block-copolymer rubber, the method comprising:
wrapping the film (1) around the article (3), wherein a machine direction of the oriented film extends circumferentially around the article (3);
seaming said film by gluing, laser welding, heat sealing, or ultrasonic bonding; and
heating the film (1) at temperature between 120 and 130° C. so as to form a tight fitting film (1) for the article (3).

17. The method according to claim 16, wherein the article (3) is recyclable or reusable plastic bottle or container.

18. The method according to claim 16 or 17, wherein the article (3) has a highly contoured surface profile.

19. A method for separating a shrink film (1, 8) from a surface of an article (3), wherein the film (1, 8) comprises a core layer (2) including polypropylene, hydrocarbon resin and block-copolymer rubber,
the method comprising exposing the film (1, 8) and the article (3) to flotation separation process.
